(19) United States
(12) Patent Application Publication
(10) Pub. No.: US 2017/0132900 A1
(43) Pub. Date: May 11, 2017

(54) MONITORING ZONE ESCAPE REMOTE MANAGEMENT SYSTEM AND METHOD THEREFOR

(71) Applicants: Se-yong Lee, Seoul (KR); Kyo-sik Hong, Seongnam (KR); TW Mobile Co., Ltd., Seoul (KR)

(72) Inventors: Se-yong Lee, Seoul (KR); Kyo-sik Hong, Seongnam (KR)

(21) Appl. No.: 15/319,343

(22) PCT Filed: Jun. 17, 2015
(86) PCT No.: PCT/KR2015/006117

§ 371 Date: Dec. 15, 2016

(30) Foreign Application Priority Data
Jun. 17, 2014 (KR) 10-2014-0073647

(51) Int. Cl. G08B 21/04; G08B 25/10; G08B 21/02; H04W 4/02

(52) U.S. Cl. CPC G08B 21/0423; H04W 4/02; G08B 25/10; G08B 21/0283

(57) ABSTRACT

The present invention relates to systems and methods for monitoring zone escape remote management. The system sets a main living area as a monitoring zone through setting of a radius or an administrative district, links with a path display module to generate an emergency signal once so as to recognize a subject to be monitored only when the subject to be monitored actually escapes from the monitoring zone, and enables a user to set a monitoring zone of a phone or a guardian to set the monitoring zone of the phone in a remote place. A guardian can change the setting of a monitoring zone for a corresponding monitoring target when the setting of the monitoring zone for a specific monitoring target needs to be changed in a remote place, and a zone escape signal is transmitted only once when the monitoring target has escaped from a zone boundary.

### TECHNICAL FIELD

The present invention relates to a monitoring zone escape remote management system and a method thereof, and more particularly, to a monitoring zone escape remote management system which sets a main living area as a monitoring zone through setting of a radius or an administrative district, links with a path display module to generate an emergency signal once so as to recognize a subject to be monitored only when the subject to be monitored actually escapes from the monitoring zone, and enables a user to set a monitoring zone of a phone or a guardian to set the monitoring zone of the phone in a remote place, thereby maximizing the convenience of use of the user and improving malfunction problems, and a method thereof.

### BACKGROUND ART

Recently, at this point individuals have highly interested in the accumulation of wealth for private property with the development of capitalism, people have taken a necessity for a service for protecting a body of an individual and a family for granted.

Actually, as a gap between the rich and the poor becomes more serious and an unemployment rate is increased, various types of violent crimes, i.e. kidnapping, robbery, and injury cases are rapidly increased.

Therefore, when robbery and kidnapping cases happen, portable high voltage apparatuses that can directly overwhelm the opponent have emerged recently. However, for the user using the portable high voltage apparatus to directly overwhelm the opponent, considerable courage and agility are required. Since the user mostly carries the high voltage apparatus in a handbag, etc., it is very difficult for him or her to take the high voltage apparatus out of the handbag under the situation that he or she is threatened with deadly weapons like a knife, etc.

Further, since the robbery, injury, and kidnapping cases mostly happen to the weak seniors, children, and women, it is very difficult for the weak users to directly overwhelm the opponent.

Therefore, recently, a security phone having a GPS function embedded therein and automatically notifying remote servers such as a server of national police agency or a server of a security company a location and an urgent situation of a user using the security phone has emerged. However, even in the case of the security phone, the user directly manipulates a mobile phone, and therefore, it is difficult to transmit specific information by manipulating a hot key of the mobile phone under the situation that the user is threatened with deadly weapons like a knife, etc.

To solve the above problem, a security phone having a predetermined home-coming path set therein and automatically transmitting path escape information over a preset telephone number when the subject to be monitored escapes from the set path has emerged in recent years.

However, such the security phone is a phone having the home-coming path set therein to determine whether the subject to be monitored escapes and transmitting an emergency signal, but a problem that the user escapes from the home-coming path in the state in which he or she forgets his or her home-coming path setting when he or she actually uses the security phone frequently occurs.

Further, the security phone continuously transmits the preset telephone number path escape information before the path setting is released when the subject to be monitored escapes from the set path, and therefore the information receiving side has inconvenience of receiving too many messages when the emergency situation does not occur.

Further, since seniors, children, or infants may be in the situation in which they escape from the set path during the non-emergency situation, and even if an emergency signal receiving side (for example, guardian) recognizes the situation in which the subject to be monitored escapes from the set path later during the non-emergency situation, the path can be set only in the security phone, and most of seniors, children, or infants may not reset the path again, the security phone continuously transmits the emergency signal to the emergency signal receiving side (for example, guardian) despite the non-emergency situation to cause great inconvenience.

### DISCLOSURE

### Technical Problem

In consideration of the above-mentioned circumstances, it is an object of the present invention to provide a monitoring zone escape remote management system which sets t, main living area as a monitoring zone through setting of a radius or an administrative district, links with a path display module to generate an emergency signal once so as to recognize a subject to be monitored on when the subject to be monitored actually escapes from the monitoring zone, and enables a user to set a monitoring zone of a phone or a guardian to set the monitoring zone of the phone in a remote place, thereby maximizing the convenience of use of the user and improving malfunction problems, rod a method thereof.

### Technical Solution

In order to accomplish the above object, according to an aspect of the present invention, there is provided a monitoring zone escape remote management method, including: a) receiving, by a location-based zone escape information management server 20, a monitoring zone setting request signal for a specific setting target phone 2 from a guardian phone 4; b) determining, by the location-based zone escape information management server 20, whether identification information of the setting target phone 2 is information of a pre-registered member; c) transmitting, by the location-based zone escape information management server 20, information of the guardian phone 4 and monitoring zone setting information to the setting target phone 2 to confirm whether a monitoring zone setting request is approved, when the identification information of the setting target phone is the information of the pre-registered member; d) changing, by a zone escape signal control application 10 of the setting target phone 2, monitoring zone information when an approval signal is generated; e) notifying, by the location-based zone escape information management server 20, that the approval signal is received by the guardian phone 4 from the setting target phone 2; f) determining, by the zone escape signal control application 10 of the setting target phone 2, whether the setting target phone escapes from a monitoring zone; g) generating, by the zone escape signal control application 10 of the setting target phone 2, zone escape information by extracting current location information, when it is determined that the setting target phone escapes from the monitoring zone; and h) transmitting, by the zone escape signal control application 10 of the setting target phone 2, the zone escape information to a pre-registered phone number.

Herein the monitoring zone escape remote management method further includes: before the a) receiving, outputting, by the zone escape signal control application 10 of the guardian phone 4, a map in which a current location of the setting target phone 2 and the monitoring zone intended to be set are displayed so as to be visually confirmed at the time of trying to change the monitoring zone information for the setting target phone.

Preferably, in the c) transmitting, the monitoring zone is set by receiving an administrative district selection signal, or by receiving a radius selection signal based on a specific address as a central point.

Preferably, in the h) transmitting, at the time of entry and escape of the setting target phone to and from a boundary of the monitoring zone, the zone escape signal control application 10 of the setting target phone 2 transmits the zone escape information once only when the setting target phone escapes from the monitoring zone, and does not transmit additional zone escape information when the zone escape state is continued.

According to another aspect of the present invention, there is provided a monitoring zone escape remote management system, including: a setting target phone 2 in which monitoring zone information is set and including a zone escape signal control application 10 which receives current location information to automatically transmit a zone escape signal to a preset phone number when the setting target phone escapes from a boundary of a monitoring zone; a guardian phone 4 including the zone escape signal control application 10 which generates a signal for changing the monitoring zone information that is preset in the setting target phone 2 in a remote place, and transmits the monitoring zone information desired to replace the preset monitoring zone information to enable resetting; and a location-based zone escape information management server 20 configured to receive a monitoring zone setting change signal for a specific phone number from the guardian phone 4, transmit an approval request signal to the setting target phone 2, and, depending on a result thereof, perform signal transfer processing so that the setting of the monitoring zone is changed through the zone escape signal control application 10.

Preferably, the zone escape signal control application 10 receives information on an absolute location from a Wi-Fi hub device 12, a GPS satellite 14, or a communication company server 16 to perform current location calculation.

Preferably, the monitoring zone information that is set through the zone escape signal control application 10 is set by designating an administrative district or by selecting a radius based on an address selected by a user.

Preferably, the setting target phone 2 includes a self setting function in which a user directly sets the monitoring zone information through the zone escape signal control application 10 installed in the setting target phone 2.

Preferably, the zone escape signal is an emergency phone call or an emergency message including zone escape information, and the emergency message includes location information of the setting target phone 2.

Preferably, the setting target phone 2 is configured to transmit zone escape information not only to the guardian phone 4, but also to a phone number pre-registered in the setting target phone 2 when escaping from the monitoring zone.

Preferably, the approval request signal received by the location-based zone escape information management server 20 from the guardian phone 4 is identification information of a setting target and monitoring zone information desired to be set, and the location-based zone escape information management server 20 determines whether the identification information of the setting target is present in membership information, and whether an approval signal is received from the setting target phone 2.

Preferably, at the time of entry and escape of the setting target phone to and from the boundary of the monitoring zone, the zone escape signal control application of the setting target phone 2 transmits zone escape information once only when the setting target phone escapes from the monitoring zone, and does not transmit additional zone escape information when the zone escape state is continued.

Preferably, the zone escape signal control application 10 of the guardian phone 4 is configured to output a map in which a current location of the setting target phone 2 and a monitoring zone intended to be set are displayed so as to be visually confirmed at the time of trying to change the monitoring zone information for the setting target phone 2.

Preferably, the zone escape signal control application 10 includes: a communication module 50 configured to transmit and receive data; an electronic map manager 52 configured to manage an electronic map for displaying location information and the monitoring zone; a monitoring zone setting unit 54 configured to set the monitoring zone; a zone boundary entry and escape calculator 56 configured to calculate whether the setting target phone enters into or escapes from the boundary of the monitoring zone by comparing current location information obtained through absolute location coordinate information with location information in the monitoring zone; a current location extractor 58 configured to extract the current location information through the absolute location coordinate information; an escape information transmitter 60 configured to generate and transmit zone escape information at the time of zone escape situation; a data storage 62 configured to store the monitoring zone information, a target phone number for escape information transmission, and electronic map information; and a controller 64 configured to process zone escape setting, and determine whether the setting target phone escapes from the monitoring zone by comparing the current location information with the monitoring zone information so as to control the zone escape information to be transmitted to the preset phone number.

Preferably, the monitoring zone setting unit 54 includes a self location setting unit 54A configured to allow a user of the setting target phone to set the monitoring zone by himself or herself; and a third-party location setting unit 54B applied with a setting signal from the guardian phone 4 in a remote place to change the monitoring zone information set by the self location setting unit 54A.

### Advantageous Effects

The monitoring zone escape remote management system and the method thereof according to the embodiment of the present invention have advantages of very conveniently changing the setting of the monitoring zone of the subject be monitored when the guardian changes the setting of the monitoring zone of the specific subject to be monitored in the remote place, thereby improving the convenience of use when the subject to be monitored is a senior and a child, and may transmit the zone escape signal only once when the subject to be monitored escapes from the zone boundary, thereby preventing the reception of the repeated zone escape messages when the subject to be monitored escape from the zone.

### DESCRIPTION OF DRAWINGS

FIG. 1 is a block diagram illustrating a schematic configuration of a monitoring zone escape remote management system according to an embodiment of the present invention.

FIG. 2 is a view illustrating a remote setting state through the monitoring zone escape remote management system according to the embodiment of the present invention.

FIG. 3 is a view for describing an emergency signal transmission state when a subject to be monitored enters and exits a monitoring zone boundary through the monitoring zone escape remote management system according to the embodiment of the present invention.

FIG. 4 is a view illustrating zone escape information transmitted when the subject to be monitored enters and exits the monitoring zone boundary through the monitoring zone escape remote management system according to the embodiment of the present invention.

FIG. 5 is a view illustrating a remote setting change state and a notification message through the monitoring zone escape remote management system according to the embodiment of the present invention.

FIG. 6 is a block diagram illustrating a configuration of a zone escape signal control application included in the monitoring zone escape remote management system according to the embodiment of the present invention.

FIGS. 7 and 8 are flow charts illustrating a signal flow of the monitoring zone escape remote management system according to the embodiment of the present invention.

FIG. 9 is a flow chart illustrating in detail a process when the subject to be monitored escapes from a zone through the monitoring zone escape remote management system according to the embodiment of the present invention.

### BEST MODE

Hereinafter, the present invention will be described in detail with reference to the accompanying drawings.

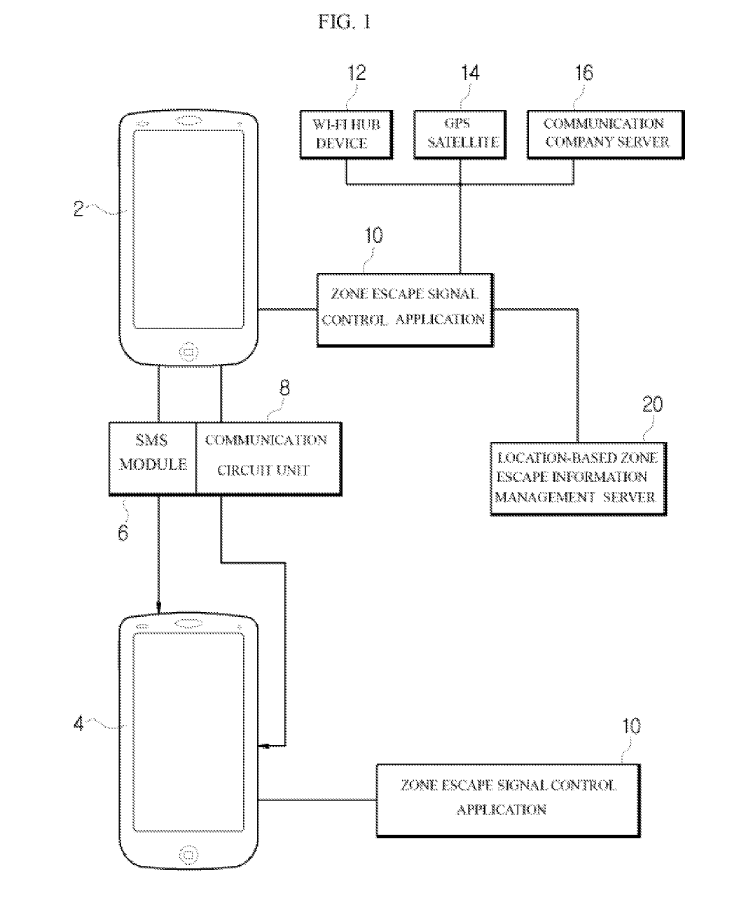

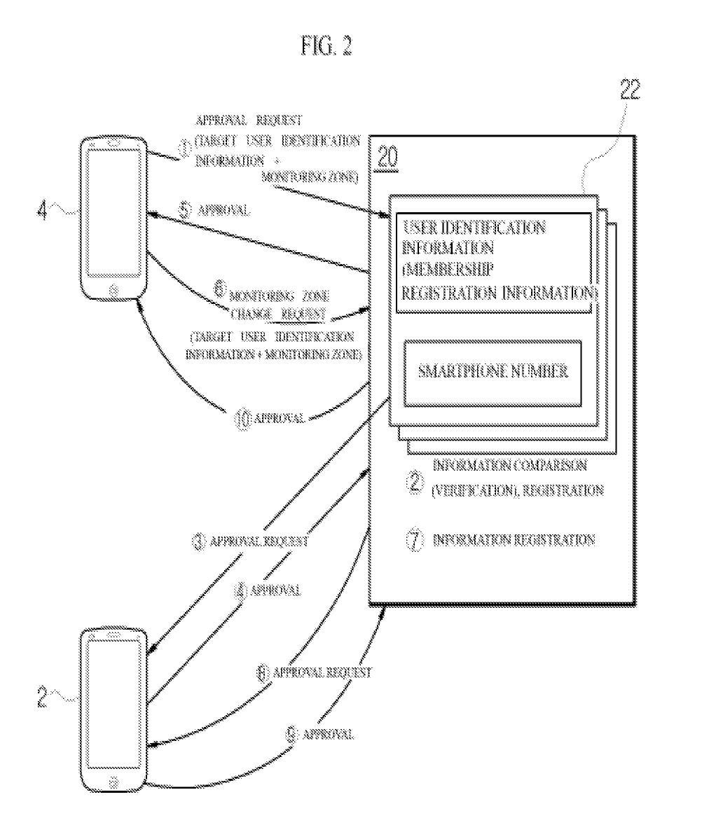

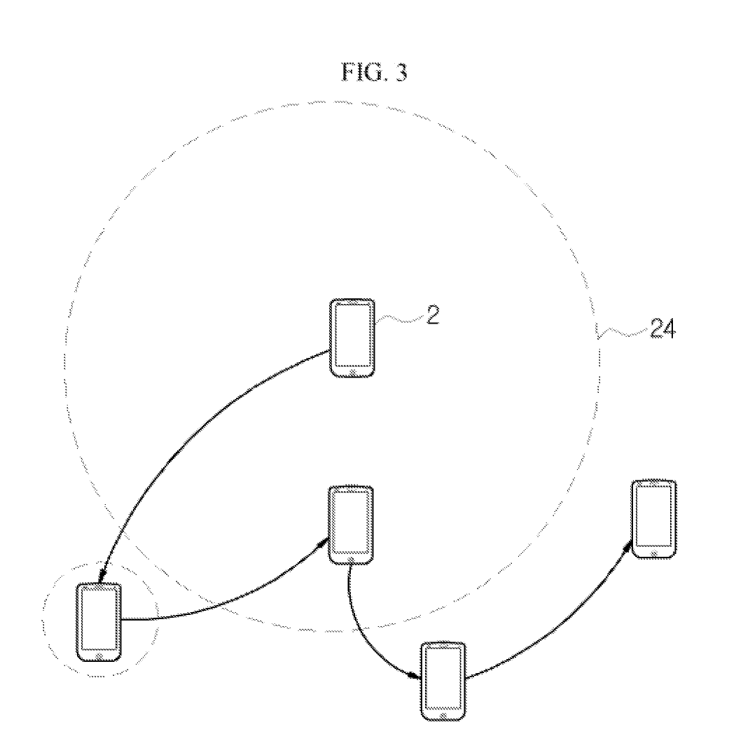

FIG. 1 is a block diagram illustrating a schematic configuration of the monitoring zone escape remote management system according to the embodiment of the present invention, FIG. 2 is a view illustrating a state in which remote setting is performed through the monitoring zone escape remote management system according to the embodiment of the present invention, and FIG. 3 is a view for describing a state in which an emergency signal is transmitted through the monitoring zone escape remote management system according to the embodiment of the present invention at the time of entering and escaping a boundary of a monitoring zone.

Referring to FIGS. 1 to 3, the monitoring zone escape remote management system according to the embodiment of the present invention is a system which sets a main living area as a monitoring zone through setting of a radius or an administrative district, links with a path di module to generate an emergency signal once so as to recognize a subject to be monitored only when the subject to be monitored actually escapes from the monitoring zone, and enables user to set the monitoring zone of a phone or a guardian to set the monitoring zone of the phone in remote place, thereby maximizing the convenience of use of the user and improving malfunction problems, and a method thereof.

More specifically, the monitoring zone escape remote management system according to the embodiment of the present invention is a system capable of allowing a guardian phone 4 of a guardian to rapidly determine whether at least one setting target phone 2 is present within a predetermined monitoring zone, or whether at least one setting target phone escapes from the monitoring zone, and allowing the guardian phone 4 of the guardian to remotely change monitoring zone setting information of the setting target phone 2 in easy way to improve the convenience of a user, and solving a problem that it is difficult for an infant, a child, or a senior to perform a control for changing the monitoring zone.

Accordingly, the monitoring zone escape remote management system according to the embodiment of the present invention includes the setting target phone 2 in which monitoring zone information is set and including a zone escape signal control application 10 which receives current location information to automatically transmit a zone escape signal to a preset phone number when the setting target phone escapes from a boundary of the monitoring zone; the guardian phone 4 including the zone escape signal control application 10 which generates a signal for changing the monitoring zone information that is preset in the setting target phone 2 in a remote place, and transmits the monitoring zone information desired to replace the preset monitoring zone information to enable resetting; and a location-based zone escape information management server 20 configured to receive a monitoring zone setting change signal for a specific phone number from the guardian phone 4, transmit an approval request signal to the setting target phone 2, and, depending on a result thereof, perform signal transfer processing so that the setting of the monitoring zone is changed through the zone escape signal control application 10.

In this case, the zone escape signal control application 10 dedicated for the setting target phone 2 or the guardian phone 4 does not exist, but the zone escape signal control application 10 may be used while being installed in the setting target phone 2 or the guardian phone 4.

Particularly, the setting target phone 2 requires the zone escape signal control application 10 to determine whether the setting target phone escapes from the monitoring zone, and transmit the zone escape signal to the specific phone number through the zone escape signal control application 10.

However, the guardian phone 4 requires the zone escape signal control application 10 to change the setting of the monitoring zone in the specific setting target phone 2 in the remote place. That is, both phones require the zone escape signal control application 10.

Accordingly, at the time of location monitoring in a state in which the zone escape signal control application is installed in the both phones, an absolute location signal is required. Thus, the zone escape signal control application 10 receives information on an absolute location from a Wi-Fi hub device 12, a GPS satellite 14, or a communication company server 16 to perform current location calculation.

Actually, the location signal received from the Wi-Fi hub device 12 or the GPS satellite 14 has little error, but since the location signal received through the communication company server 16 is a location signal based on trigonometry calculation using a base station, an error of 1 or 2 kilometers may occur. However, since there are cases in which the signal may not be received from the Wi-Fi hub device 12 or the GPS satellite 14, thus the signal provided from the communication company server 16 may not be excluded.

Meanwhile, the monitoring zone information that is set through the zone escape signal control application 10 is set by designating an administrative district or by selecting a radius based on an address selected by the user.

That is, the user of the guardian phone 4 may set the escape of the specific setting target phone 2 from the monitoring zone by selecting the administrative district or by selecting the radius based on an address selected by the user, in which the radius may be selected in a manner like 500 meters, 1 kilometer, 2 kilometers, 3 kilometers, 5 kilometers, 10 kilometers, . . . and 100 kilometers.

More preferably, the zone escape signal control application 10 of the guardian phone 4 is configured to output a map in which a current location of the setting target phone 2 and the monitoring zone intended to be set are displayed so as to be visually confirmed at the time of trying to change the monitoring zone information for the setting target phone 2.

Therefore, the guardian may easily recognize the currently set zone on the map, and set the monitoring zone while outputting the monitoring zone on the map in a manner of visibly dragging the newly set monitoring zone to contract or expand the monitoring zone.

Meanwhile, the setting target phone 2 also includes a self setting function in which the user directly sets the monitoring zone information through the zone escape signal control application 10 installed in the setting target phone 2.

That is, the user may set the specific monitoring zone by himself or herself through the zone escape signal control application 10 installed in the setting target phone 2, and set the setting target phone so as to transmit the zone escape signal to the preset specific phone number when the user escapes from the monitoring zone.

In this case, in a state in which a person living in Gangnam-gu sets Gangnam-gu as the monitoring zone, by allowing the setting target phone to transmit his or her escape information to people such as a lover, or parents when the setting target phone escapes from Gangnam-gu, a zone escape signal including location information may be transmitted to people around him or her in a situation like kidnapping.

In particular, the monitoring zone escape remote management system according to the embodiment of the present invention is a system in which the setting of the monitoring zone may be changed in a remote place, and thus when, for example, a guardian of a senior is sons or daughters of the senior, and the senior goes out together with a caregiver of a social welfare facility, the guardian of the senior may easily change the setting of the monitoring zone set in the setting target phone 2 carried by the senior in the remote place according to a request of the caregiver.

Further, in a case of parents having a child who is a student taking a class at a private educational institute, the child may not easily change the monitoring zone set by the parents due to psychological reasons. In addition, the present invention provides excellent convenience, since when the student is placed in an unscheduled situation such as a birthday party of his or her friend, the parents may easily perform remote setting of the monitoring zone with, for example, a radius of 2 kilometers from a house of the friend as a central point, in the remote place.

More preferably, the zone escape signal is an emergency phone call or an emergency message including zone escape information, in which the emergency message includes location information of the setting target phone 2.

Meanwhile, the setting target phone 2 is configured to transmit the zone escape information not only to the guardian phone 4, but also to a phone number pre-registered in the setting target phone 2 when escaping from the monitoring zone.

As the zone escape information includes a voice call and a text message, a general communication circuit unit 8 provided in the setting target phone 2 for the voice call, works in conjunction with the zone escape signal control application 10, and a general SMS module 6 for transmitting the zone escape information using the text message is also configured to work in conjunction with the zone escape signal control application 10.

That is, the zone escape signal control application 10 may transmit the zone escape signal through the voice call or the text message.

Meanwhile, the approval request signal received by the location-based zone escape information management server 20 included in the monitoring zone escape remote management system according to the embodiment of the present invention from the guardian phone 4 is identification information of a setting target and monitoring zone information desired to be set, and the location-based zone escape information management server 20 determines whether the identification information of the setting target is present in membership information, and whether an approval signal is received from the setting target phone 2.

To this end, the location-based zone escape information management server 20 builds a database 20 for membership registration, which includes membership information 22 including user identification information, for example, membership registration information, smartphone number information.

Meanwhile, in the monitoring zone escape remote management system according to the embodiment of the present invention, when the setting target phone 2 escapes from the specific monitoring zone, if the zone escape signal control application 10 of the setting target phone 2 continuously generates the monitoring zone escape signal to the pre-registered phone number, convenience of the user may be significantly deteriorated.

The reason is that, the guardian may recognize the location of the setting target phone 2 by using a known technique, a path tracking function that exists already, therefore, it is enough that whether the setting target phone escapes from the monitoring zone may be recognized, and the monitoring zone setting may be easily changed in a remote place according to the present invention.

Accordingly, in the monitoring zone escape remote management system according to the embodiment of the present invention, at the time of entry and escape of the setting target phone 2 to and from the boundary of the monitoring zone, the zone escape signal control application 10 of the setting target phone transmits the zone escape information once only when the setting target phone escapes from the monitoring zone, and does not transmit additional zone escape information when the zone escape state is continued.

That is, as illustrated in FIG. 3, when the setting target phone 2 escapes from the monitoring zone 24, the signal is generated once, and when the setting target phone 2 enters into the monitoring zone 24 again, the signal is not generated. Similarly, when the setting target phone 2 escapes from the monitoring zone 24, the signal is generated once, and when the setting target phone 2 is located an outside of the monitoring zone 24 for a long time, a separate escape signal is not generated.

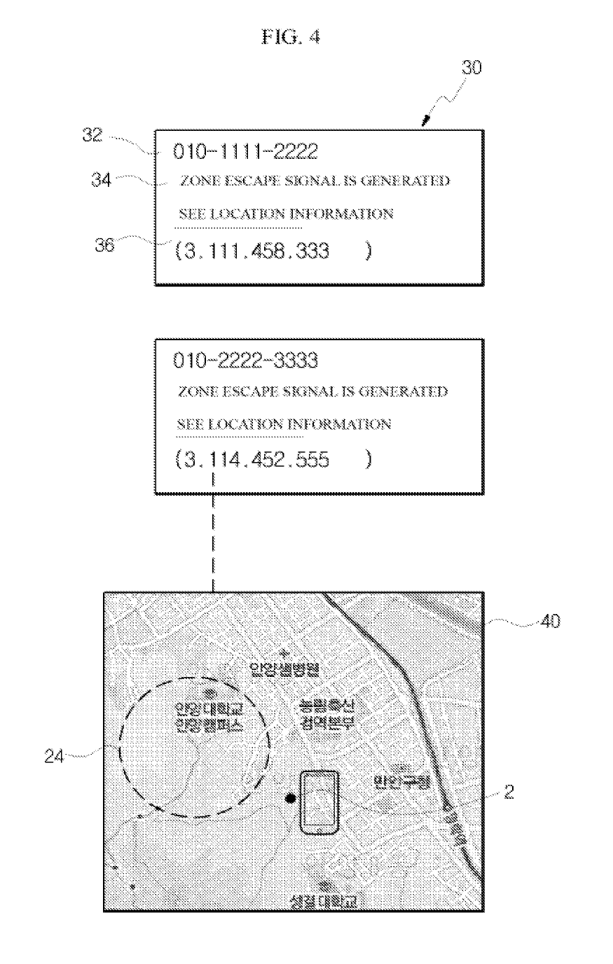

FIG. 4 is a view illustrating zone escape information transmitted when escaping from a boundary of a monitoring zone through the monitoring zone escape remote management system according to the embodiment of the present invention.

Referring to FIG. 4, the zone escape information 30 transmitted from the setting target phone 2 included in the monitoring zone escape remote management system according to the embodiment of the present invention to a preset signal reception target (e.g., the guardian phone 4, hereinafter, referred to as a guardian phone) includes identification information 32, a zone escape message 34, and location information 36 of the setting target phone 2.

Preferably, when the location information 36 among the zone escape information 30 output in the guardian phone 4 is selected, as illustrated in FIG. 4, the zone escape signal control application 10 performs data processing so that a map in which the set monitoring zone 24 and the current location information are displayed is output.

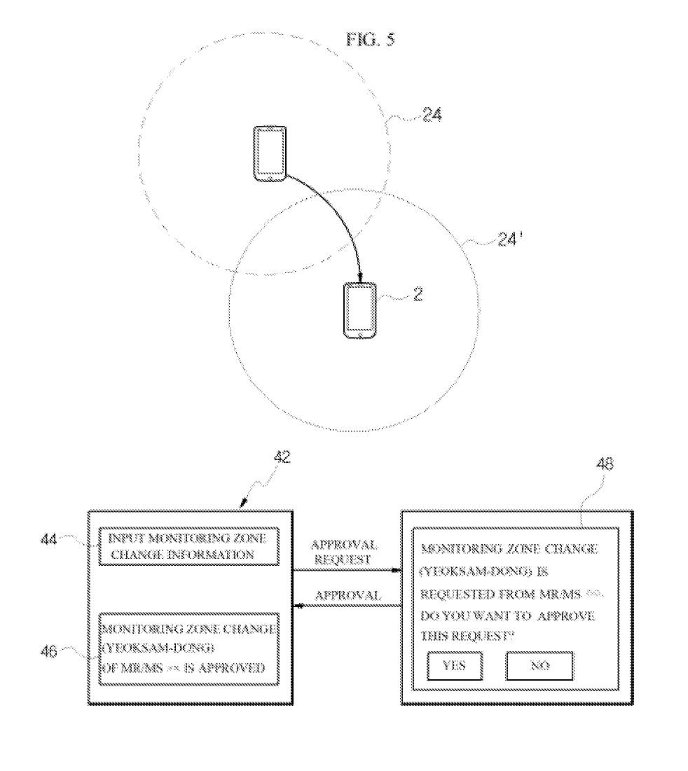

FIG. 5 is a view illustrating a state in which the setting is remotely changed through the monitoring zone escape remote management system according to the embodiment of the present invention, and notification messages.

Referring to FIG. 5, the state in which the setting is remotely changed through the monitoring zone escape remote management system according to the embodiment of the present invention may be achieved by driving the zone escape signal control application 10 of the guardian phone 4 as illustrated in FIG. 5, thereby monitoring zone change information is input by driving the zone escape signal control application 10.

At this point, the monitoring zone change information 44 includes identification information of the setting target phone 2 and monitoring zone information desired to replace, and is input through a screen 42 of the guardian phone 4 to be transmitted to the setting target phone 2.

Then, the monitoring zone change information 44 is transmitted to the setting target phone 2 through the location-based zone escape information management server 20, and monitoring zone change request information 48 output in the setting target phone 2 is output as a message “Monitoring zone change (Yeoksam-dong) is requested from Mr/Ms ∘∘. Do you want to approve this request?” together with an approval button and a denial button as illustrated in FIG. 5.

If the user of the setting target phone 2 selects approval, the information is transmitted to the guardian phone 4 through the location-based zone escape information management server 20 and approval information 46 “Monitoring zone change (Yeoksam-dong) of Mr/Ms xx is approved” is output on the screen.

Accordingly, the setting target and the guardian may easily set the specific monitoring zone in the remote place through the monitoring zone escape remote management system according to the embodiment of the present invention, respectively, and may determine whether to approve by confirming where the monitoring zone is, thereby improving convenience.

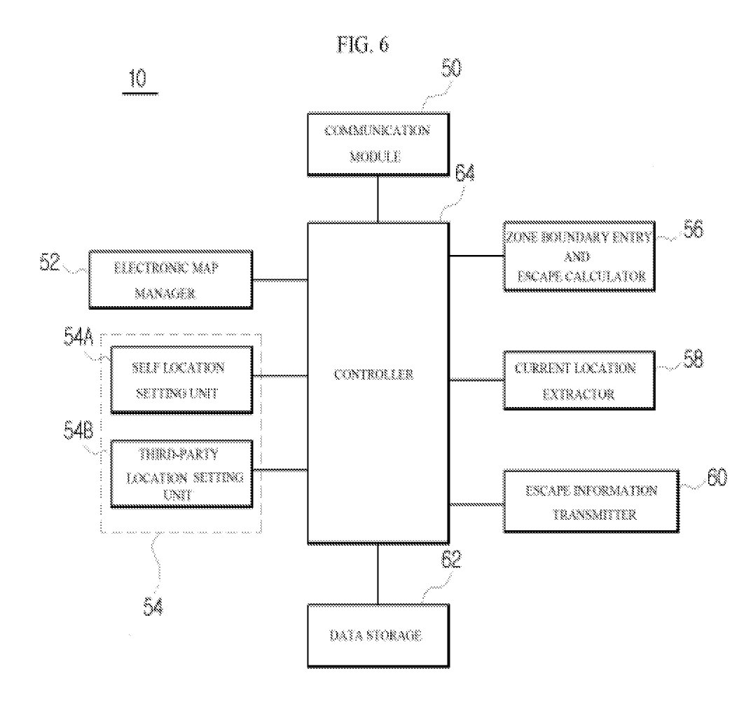

FIG. 6 is a block diagram illustrating a configuration of the zone escape signal control application included in the monitoring zone escape remote management system according to the embodiment of the present invention.

Referring to FIG. 6, the zone escape signal control application 10 included in the monitoring zone escape remote management system according to the embodiment of the present invention includes a communication module 50 configured to transmit and receive data; an electronic map manager 52 configured to manage an electronic map for displaying the location information and the monitoring zone; a monitoring zone setting unit 54 configured to set the monitoring zone; a zone boundary entry and escape calculator configured to calculate whether a setting target phone enters into or escapes from a boundary of the monitoring zone by comparing current location information obtained through absolute location coordinate information with location information in the monitoring zone; a current location extractor 58 configured to extract the current location information through the absolute location coordinate information; an escape information transmitter 60 configured to generate and transmit zone escape information at the time of zone escape situation; a data storage 62 configured to store monitoring zone information, a target phone number for escape information transmission, and electronic map information; and a controller 64 configured to process zone escape setting, and determine whether the setting target phone escapes from the monitoring zone by comparing the current location information with the monitoring zone information so as to control the zone escape information to be transmitted to a preset phone number.

Preferably, the monitoring zone setting unit 54 includes a self location setting unit 54A configured to allow a user of the setting target phone to set the monitoring zone by himself or herself; and a third-party location setting unit 54B applied with a setting signal from the guardian phone 4 in a remote place to change the monitoring zone information set by the self location setting unit 54A.

Functions and operation of the monitoring zone escape remote management system according to the embodiment of the present invention configured as described above will be described in detail with reference to the accompanying drawings.

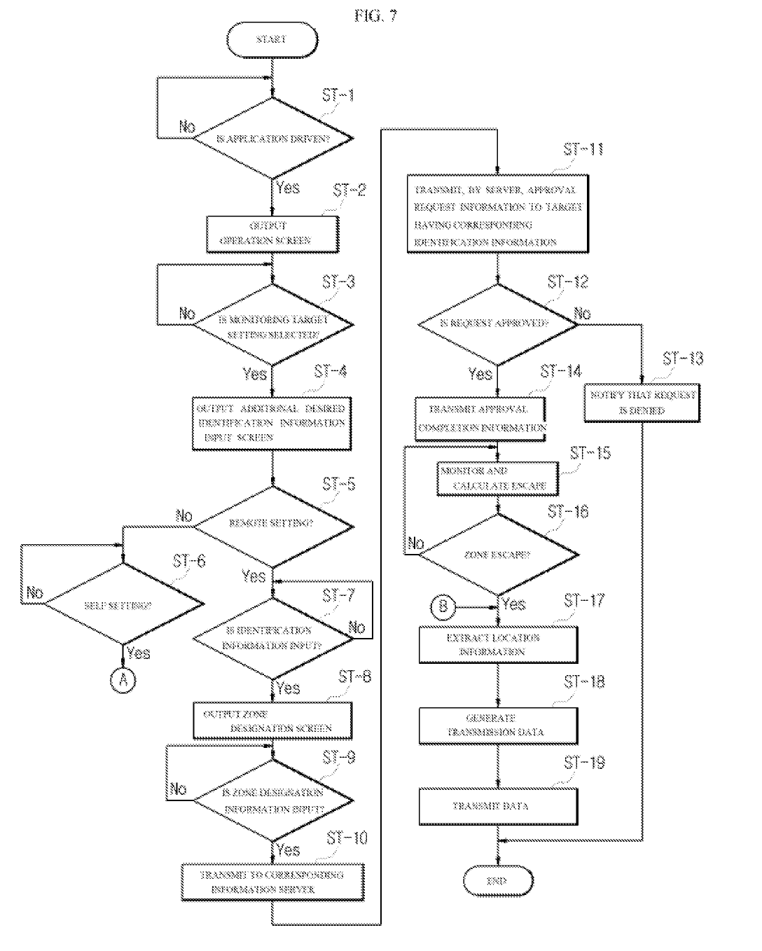

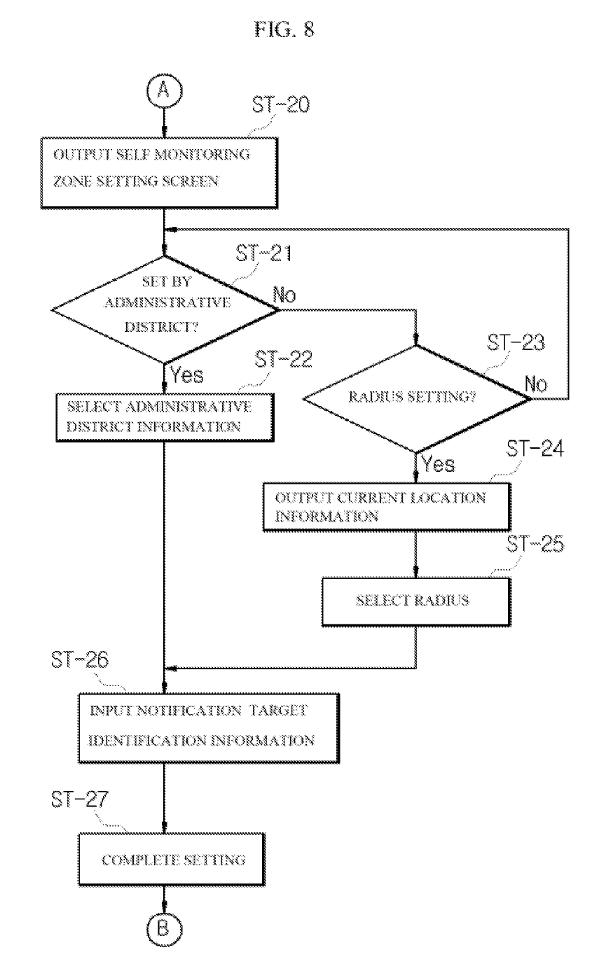

FIGS. 7 and 8 are flow charts illustrating a signal flow of the monitoring zone escape remote management system according to the embodiment of the present invention.

Referring to FIG. 7, when the guardian drives the zone escape signal control application 10 of the guardian phone 4 in order to try to remotely change the setting of the monitoring zone, the zone escape signal control application outputs an operation screen for changing the monitoring zone.

In this state, the zone escape signal control application 10 determines whether a setting selection signal of a monitoring target is applied, and when the setting selection signal of the monitoring target is applied, the zone escape signal control application 10 outputs a desired identification information input screen.

At this point, the zone escape signal control application 10 receives a signal for determining whether the monitoring target is a third party or a user himself or herself. According to the present invention, the user may set a specific third party as the monitoring target (referred to as remote setting), and may also set the user himself or herself as the monitoring target (referred to as self setting).

In the case of the remote setting in which the third party is set as the monitoring target, the zone escape signal control application 10 determines whether user identification information of the setting target phone 2 that is the monitoring target is received.

For example, the user identification information is configured of information except for the phone number, such as an e-mail address, or the like, thereby making it difficult to try to set the monitoring zone for fun.

When the identification information is applied, the zone escape signal control application 10 outputs a zone designation screen.

As described above, designation of the zone may be performed based on the administrative district, or may also be performed by inputting a specific address and selecting a radius based on the address as a central point.

Preferably, the zone escape signal control application 10 of the guardian phone 4 outputs a map in which the current location of the setting target phone 2 and the monitoring zone intended to be set are displayed so as to be visually confirmed at the time of trying to change the monitoring zone information for the setting target phone 2.

When the zone designation is performed, the zone escape signal control application 10 transmits the information to the location-based zone escape information management server 20.

Then, the location-based zone escape information management server 20 determines whether a pre-registered member having the identification information exists, and transmits the monitoring zone change request information by extracting a phone number matched to the identification information.

That is, the monitoring zone change request information 48 is output as a message “Monitoring zone change (Yeoksam-dong) is requested from Mr/Ms ∘∘. Do you want to approve this request?” together with the approval button and the denial button.

If the user of the setting target phone 2 selects approval, the information is transmitted to the guardian phone 4 through the location-based zone escape information management server 20 and approval information 46 “Monitoring zone change (Yeoksam-dong) of Mr/Ms xx is approved” is output on the screen.

On the other hand, when the setting target phone 2 selects denial, a denial message is transmitted to the guardian phone 4.

In this state, the zone escape signal control application 10 of the setting target phone 2 determines whether the setting target phone 2 escapes from the monitoring zone, and when it is determined that the setting target phone escapes from the monitoring zone, the zone escape signal control application 10 generates the zone escape information by extracting the current location information.

Then, the zone escape signal control application 10 of the setting target phone 2 transmits the zone escape information to the pre-registered phone number.

Even in the case of the self setting, as illustrated in FIG. 8, although the approval process is omitted, the user drives the zone escape signal control application 10 of the setting target phone 2 by himself or herself to set the monitoring zone.

As described above, the designation of the zone may be performed based on the administrative district, or may also be performed by inputting a specific address and selecting a radius based on the address as the central point.

Similarly, the zone escape signal control application 10 of the setting target phone 4 outputs a map in which the current location of the setting target phone 2 and the monitoring zone intended to be set are displayed so as to be visually confirmed.

Meanwhile, when target information notifying the zone escape information at the time of escape from the monitoring zone is input to the zone escape signal control application 10 of the setting target phone 2, the setting is completed.

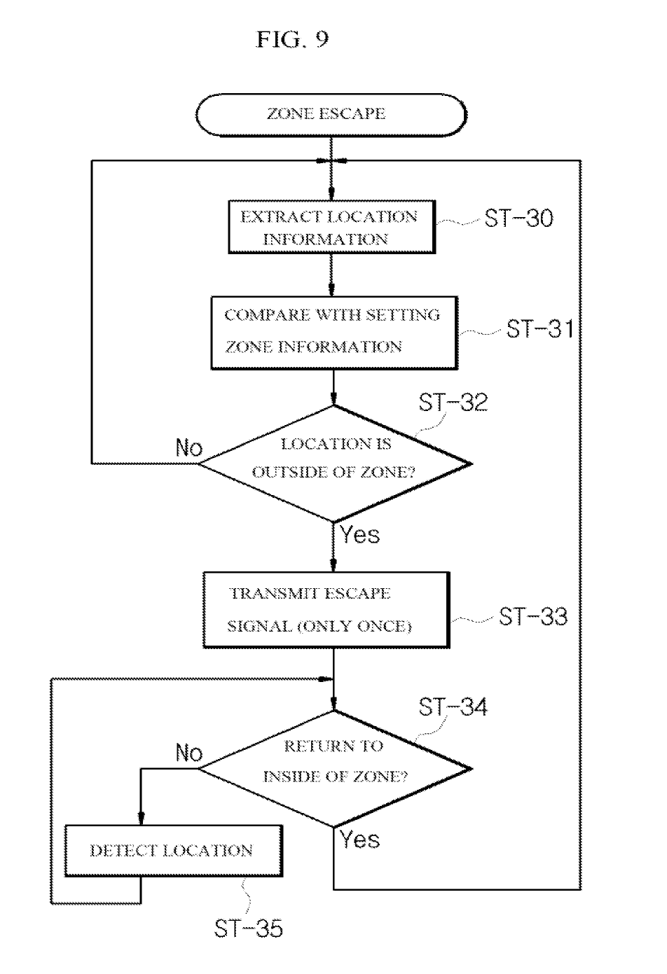

FIG. 9 is a flow chart illustrating a process at the time of escape from the monitoring zone through the monitoring zone escape remote management system according to the embodiment of the present invention in detail.

Referring to FIG. 9, the monitoring zone escape remote management system according to the embodiment of the present invention is designed in a structure of improving convenience at the time of escape from the monitoring zone.

That is, in the monitoring zone escape remote management system according to the embodiment of the present invention, when the setting target phone 2 escapes from the specific monitoring zone, if the zone escape signal control application 10 of the setting target phone 2 continuously generates the monitoring zone escape signal to the pre-registered phone number, convenience of the user may be significantly deteriorated.

The reason is that, the guardian may recognize the location of the setting target phone 2 by using a known technique, a path tracking function that exists already, therefore, it is enough that whether the setting target phone escapes from the monitoring zone may be recognized, and the monitoring zone setting may be easily changed in the remote place according to the present invention.

Accordingly, in the monitoring zone escape remote management system according to the embodiment of the present invention, at the time of entry and escape of the setting target phone 2 to and from the boundary of the monitoring zone, the zone escape signal control application 10 of the setting target phone transmits the zone escape information once only when the setting target phone escapes from the monitoring zone, and does not transmit additional zone escape information when the zone escape state is continued.

That is, when the setting target phone 2 escapes from the monitoring zone 24, the signal is generated once, and when the setting target phone 2 enters into the monitoring zone 24 again, the signal is not generated.

Similarly, when the setting target phone 2 escapes from the monitoring zone 24, the signal is generated once, and when the setting target phone 2 is located outside the monitoring zone 24 for a long time, a separate escape signal is not generated.

However, when it is used in conjunction with a known path extracting function, the location of the monitoring target is continuously tracked.

Meanwhile, the monitoring zone escape remote management system according to the embodiment of the present invention and the method thereof are not limited to the above-described specific embodiments, and it will be understood by those skilled in the related art that various modifications and variations may be made therein without departing from the scope of the present invention as defined by the appended claims.

### DESCRIPTION OF REFERENCE NUMERALS

2: setting target phone, 4: guardian phone
10: zone escape signal control application
12: Wi-Fi hub device,
14: GPS satellite, 16: communication company server
20: location-based zone escape information management server

1. A monitoring zone escape remote management method, comprising:
a) receiving, by a location-based zone escape information management server, a monitoring zone setting request signal for a specific setting target phone from a guardian phone;
b) determining, by the location-based zone escape information management server, whether identification information of the setting target phone is information of a pre-registered member;
c) transmitting, by the location-based zone escape information management server, information of the guardian phone and monitoring zone setting information to the setting target phone to confirm whether a monitoring zone setting request is approved, when the identification information of the setting target phone is the information of the pre-registered member;
d) changing, by a zone escape signal control application of the setting target phone, monitoring zone information when an approval signal is generated;
e) notifying, by the location-based zone escape information management server, that the approval signal is received by the guardian phone from the setting target phone;
f) determining, by the zone escape signal control application of the setting target phone, whether the setting target phone escapes from a monitoring zone;
g) generating, by the zone escape signal control application of the setting target phone, zone escape information by extracting current location information, when it is determined that the setting target phone escapes from the monitoring zone; and
h) transmitting, by the zone escape signal control application of the setting target phone, the zone escape information to a pre-registered phone number.

2. The monitoring zone escape remote management method of claim 1, further comprising: before step a), outputting, by the zone escape signal control application of the guardian phone, a map in which a current location of the setting target phone and the monitoring zone intended to be set are displayed so as to be visually confirmed at the time of trying to change the monitoring zone information for the setting target phone.

3. The monitoring zone escape remote management method of claim 1, wherein in step c), the monitoring zone is set by receiving an administrative district selection signal, or by receiving a radius selection signal based on a specific address as a central point.

4. The monitoring zone escape remote management method of claim 1, wherein, in step h), at the time of entry and escape of the setting target phone to and from a boundary of the monitoring zone, the zone escape signal control application of the setting target phone transmits the zone escape information once only when the setting target phone escapes from the monitoring zone, and does not transmit additional zone escape information when the zone escape state is continued.

5. A monitoring zone escape remote management system, comprising:
a setting target phone in which monitoring zone information is set and including a zone escape signal control application which receives current location information to automatically transmit a zone escape signal to a preset phone number when the setting target phone escapes from a boundary of a monitoring zone;
a guardian phone including the zone escape signal control application which generates a signal for changing the monitoring zone information that is preset in the setting target phone in a remote place, and transmits the monitoring zone information desired to replace the preset monitoring zone information to enable resetting; and
a location-based zone escape information management server configured to receive a monitoring zone setting change signal for a specific phone number from the guardian phone, transmit an approval request signal to the setting target phone, and, depending on a result thereof, perform signal transfer processing so that the setting of the monitoring zone is changed through the zone escape signal control application.

6. The monitoring zone escape remote management system of claim 5, wherein the zone escape signal control application receives information on an absolute location from a Wi-Fi hub device, a GPS satellite, or a communication company server to perform current location calculation.

7. The monitoring zone escape remote management system of claim 5, wherein the monitoring zone information that is set through the zone escape signal control application is set by designating an administrative district or by selecting a radius based on an address selected by a user.

8. The monitoring zone escape remote management system of claim 5, wherein the setting target phone includes a self setting function in which a user directly sets the monitoring zone information through the zone escape signal control application installed in the setting target phone.

9. The monitoring zone escape remote management system of claim 5, wherein the zone escape signal is an emergency phone call or an emergency message including zone escape information, and the emergency message includes location information of the setting target phone.

10. The monitoring zone escape remote management system of claim 5, wherein the setting target phone is configured to transmit zone escape information not only to the guardian phone, but also to a phone number pre-registered in the setting target phone when escaping from the monitoring zone.

11. The monitoring zone escape remote management system of claim 5, wherein the approval request signal received by the location-based zone escape information management server from the guardian phone is identification information of a setting target and monitoring zone information desired to be set, and the location-based zone escape information management server determines whether the identification information of the setting target is present in membership information, and whether an approval signal is received from the setting target phone.

12. The monitoring zone escape remote management system of claim 5, wherein at the time of entry and escape of the setting target phone to and from the boundary of the monitoring zone, the zone escape signal control application of the setting target phone transmits zone escape information once only when the setting target phone escapes from the monitoring zone, and does not transmit additional zone escape information when the zone escape state is continued.

13. The monitoring zone escape remote management system of claim 5, wherein the zone escape signal control application of the guardian phone is configured to output a map in which a current location of the setting target phone and a monitoring zone intended to be set are displayed so as to be visually confirmed at the time of trying to change the monitoring zone information for the setting target phone.

14. The monitoring zone escape remote management system of claim 5, wherein the zone escape signal control application includes:
a communication module configured to transmit and receive data;
an electronic map manager configured to manage an electronic map for displaying location information and the monitoring zone;
a monitoring zone setting unit configured to set the monitoring zone;
a zone boundary entry and escape calculator configured to calculate whether the setting target phone enters into or escapes from the boundary of the monitoring zone by comparing current location information obtained through absolute location coordinate information with location information in the monitoring zone;
a current location extractor configured to extract the current location information through the absolute location coordinate information;
an escape information transmitter configured to generate and transmit zone escape information at the time of zone escape situation;
a data storage configured to store the monitoring zone information, a target phone number for escape information transmission, and electronic map information; and
a controller configured to process zone escape setting, and determine whether the setting target phone escapes from the monitoring zone by comparing the current location information with the monitoring zone information so as to control the zone escape information to be transmitted to the preset phone number.

15. The monitoring zone escape remote management system of claim 14, wherein the monitoring zone setting unit includes a self location setting unit configured to allow a user of the setting target phone to set the monitoring zone by himself or herself; and
a third-party location setting unit applied with a setting signal from the guardian phone in a remote place to change the monitoring zone information set by the self location setting unit.
